(19) United States
(12) Patent Application Publication
(10) Pub. No.: US 2015/0170393 A1
(43) Pub. Date: Jun. 18, 2015

(54) CONTROL DEVICE AND CONTROL SYSTEM

(71) Applicant: FUJITSU LIMITED, Kawasaki-shi (JP)

(72) Inventor: Takatoshi TADA, Numazu (JP)

(73) Assignee: FUJITSU LIMITED, Kawasaki-shi (JP)

(21) Appl. No.: 14/569,053

(22) Filed: Dec. 12, 2014

(30) Foreign Application Priority Data
Dec. 18, 2013 (JP) 2013-261621

(51) Int. Cl. G06T 11/60; G06K 9/00; G06F 3/041; H04N 1/00; H04N 1/21

(52) U.S. Cl. CPC G06T 11/60; H04N 1/00244; H04N 1/2125; G06F 3/041; G06K 9/00671

(57) ABSTRACT

A non-transitory computer readable storage medium storing a program, which when executed by a computer including an image capturing device and a display, causes the computer to: obtain identification information associated with a specific object in an image captured by the image capturing device; determine an access destination to be accessed for acquiring content data, from among a server which communicates with the computer via a first network or a local storage device which communicates with the computer via a second network different from the first network, based on the identification information; acquire the content data from the determined access destination; and control the display to superimpose a specific image corresponding to the acquired content data on the image.

### CROSS-REFERENCE TO RELATED APPLICATION

This application is based upon and claims the benefit of priority from the prior Japanese Patent Application No. 2013-261621, filed on Dec. 18, 2013, the entire contents of which are incorporated herein by reference.

### FIELD

The embodiments discussed herein are related to a technique of controlling a device in an access destination.

### BACKGROUND

An augmented reality (AR) technology has heretofore been known. In the AR technology, when a captured image captured by an image pickup function of a terminal device contains an image of a predetermined reference subject, the terminal device downloads contents information corresponding to the reference subject from a server, and displays the downloaded contents information on the captured image in a superimposing manner.

The contents information displayed and superimposed on the captured image is sometimes edited in the terminal device. In this case, the edited contents information is uploaded to the server, so that the edited contents information is shared among multiple terminal devices.

Note that techniques related to these are disclosed in, for example, Japanese Laid-open Patent Publication Nos. 2012-168798, 2000-122907, 2004-094682.

### SUMMARY

According to an aspect of the invention, a non-transitory computer readable storage medium storing a program, which when executed by a computer including an image capturing device and a display, causes the computer to: obtain identification information associated with a specific object in an image captured by the image capturing device; determine an access destination to be accessed for acquiring content data, from among a server which communicates with the computer via a first network or a local storage device which communicates with the computer via a second network different from the first network, based on the identification information; acquire the content data from the determined access destination; and control the display to superimpose a specific image corresponding to the acquired content data on the image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of a control system;

FIG. 2 is a diagram illustrating an example of the hardware configuration of a terminal device;

FIG. 3 is a diagram illustrating a functional configuration of each device included in the control system;

FIG. 4 is a diagram illustrating an example of a communication destination table;

FIG. 5 is a flowchart illustrating an operation of the terminal device according to a first embodiment;

FIG. 6 is a diagram illustrating an example of a display in which contents information is superimposed on a captured image; and

FIG. 7 is a flowchart illustrating an operation of a terminal device according to a second embodiment.

### DESCRIPTION OF EMBODIMENTS

A communication status between a terminal device and a server varies depending on a communication performance of each terminal device. For this reason, in the above-described technique, an inconsistency may be caused in sharing the contents information among the multiple terminal devices.

For example, the timing of uploading the edited contents information to the server varies depending on the communication status between the terminal device and the server. Accordingly, there is a possibility that another terminal device may download the contents information to be edited before some terminal device uploads the edited contents information to the server. In addition, for example, a location in which the terminal device picks up an image of a reference subject is outside a communication service between the terminal device and the server, the terminal device is incapable of downloading the edited contents information from the server.

In one aspect, an object of the disclosed technique is to suppress generation of inconsistency in sharing the contents information.

### First Embodiment

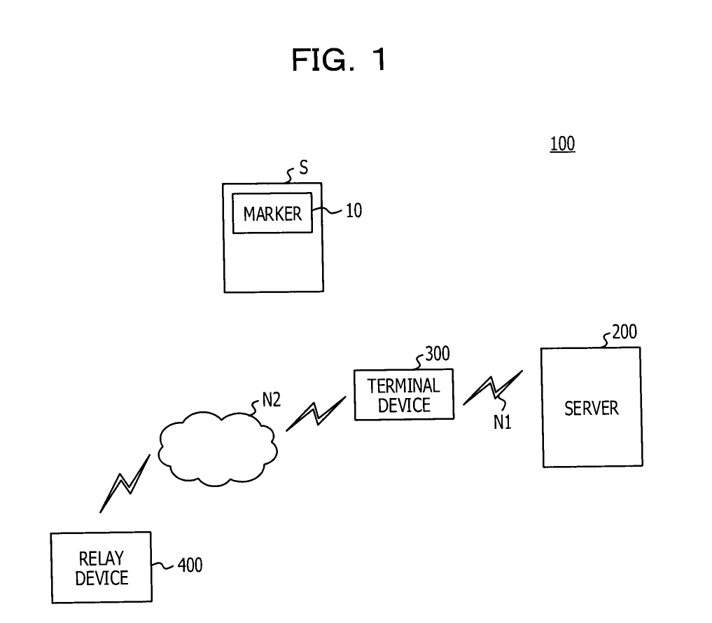

Hereinafter, embodiments are described based on the drawings. FIG. 1 is a diagram illustrating the configuration of a control system.

A control system 100 of an embodiment has a server 200, a terminal device 300, and a relay device 400. The server 200 of the embodiment communicates with the terminal device 300 via a mobile data communication network N1 or the like.

The terminal device 300 of the embodiment has an image pickup function, which is configured to capture an image of a subject S to which a marker 10 is attached, for example, and displays, on a display device, contents information which corresponds to the image of marker 10 included in the captured image.

The relay device 400 of the embodiment couples with the terminal device 300 via a wireless local area network (LAN) communication network N2. Also, the relay device 400 of the embodiment has a storage device and functions as a storage device to temporary store data. Specifically, the relay device 400 of the embodiment becomes a storage device to store the contents information corresponding to the marker 10.

The marker 10 and the contents information according to the embodiment are described below.

The marker 10 of the embodiment is an augmented reality (AR) marker, which is a predetermined pattern image to be an index to designate a position in which the contents information is displayed. The contents information of the embodiment is model data of a three-dimensional (3D) object which is arranged on a 3D virtual space corresponding to a real space is displayed on the captured image which is captured by the terminal device 300. The contents information of the embodiment is associated with the marker 10 and includes various forms such as a text, an icon, and an animation.

The relay device 400 is used as a storage device for multiple terminal devices 300 to share the contents information corresponding to the marker 10.

When the terminal device 300 identifies an image of the marker in the captured image, the terminal device 300 makes an access to the relay device 400 and acquires the contents information corresponding to the marker 10. When the contents information is edited in the terminal device 300, the terminal device 300 stores the edited contents information in the relay device 400. In other words, the terminal device 300 of the embodiment is a control device configured to control a destination to which the terminal device 300 itself makes an access according to the marker 10.

As described above, in the embodiment, a location for storing the contents information corresponding to the marker 10 is set in the relay device 400 in advance, so that the latest contents information may be shared among the multiple terminal devices 300 regardless of the communication status between the terminal device 300 and the server 200.

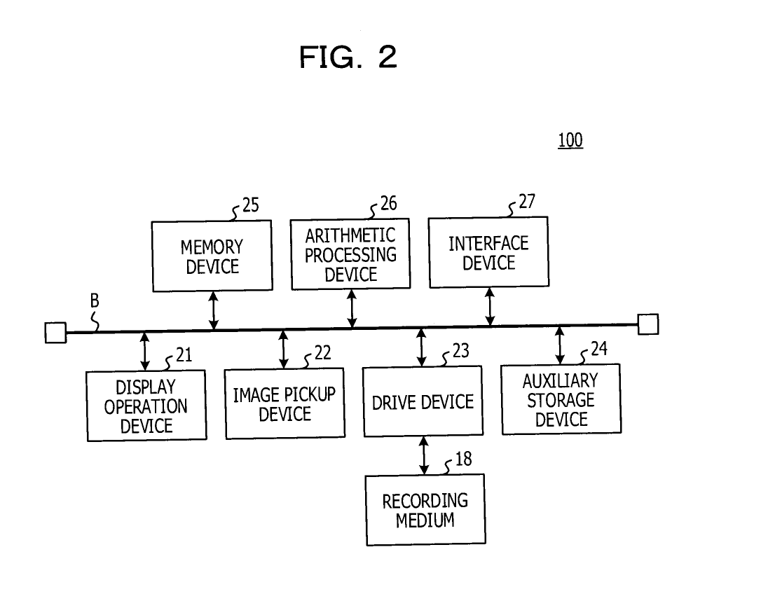

Hereinafter, the hardware configuration of the terminal device 300 according to the embodiment is described by referring to FIG. 2.

FIG. 2 is a diagram illustrating an example of the hardware configuration of the terminal device 300.

The terminal device 300 of the embodiment includes a display operation device 21, an image pickup device 22, a drive device 23, an auxiliary storage device 24, a memory device 25, an arithmetic processing device 26, and an interface device 27, which are coupled with one another via a bus B.

For example, the display operation device 21 is a touch panel or the like, and is used to input and display (output) various kinds of signals. The image pickup device 22 has an image pickup element and is used to capture an image. The interface device 27 includes a modem, a LAN card, or the like and is used to couple with each of the networks N1 and N2.

A control program is at least part of various kinds of programs for controlling the terminal device 300. The control program is provided by being distributed with a recording medium 18 or being downloaded from the network, for example. Examples of the recording medium 18 usable for storing the control program include a various types of recording media such as storage devices which optically, electrically, or magnetically records information like a CD-ROM, a flexible disk, and a magneto-optical disk or a semiconductor memory which electrically records information like a ROM, a flash memory, or the like.

When the recording medium 18 storing the control program is set in the drive device 23, the control program is installed in the auxiliary storage device 24 via the drive device 23 from the recording medium 18. The control program downloaded from the network is installed in the auxiliary storage device 24 via the interface device 27.

The auxiliary storage device 24 stores the installed control program and stores desired files, data, and the like. The memory device 25 reads the control program from the auxiliary storage device 24 and stores the read control program at the time of starting up the computer. Then, the arithmetic processing device 26 achieves various kinds of processing to be described later according to the control program stored in the memory device 25.

It is to be noted that the server 200 of the embodiment may be a general computer having a mobile data communication function, and, thus, the hardware configuration thereof is omitted. Also, the relay device 400 of the embodiment has a storage device storing the contents information and is a radio wave relay device configured to couple the terminal devices 300 via a wireless LAN.

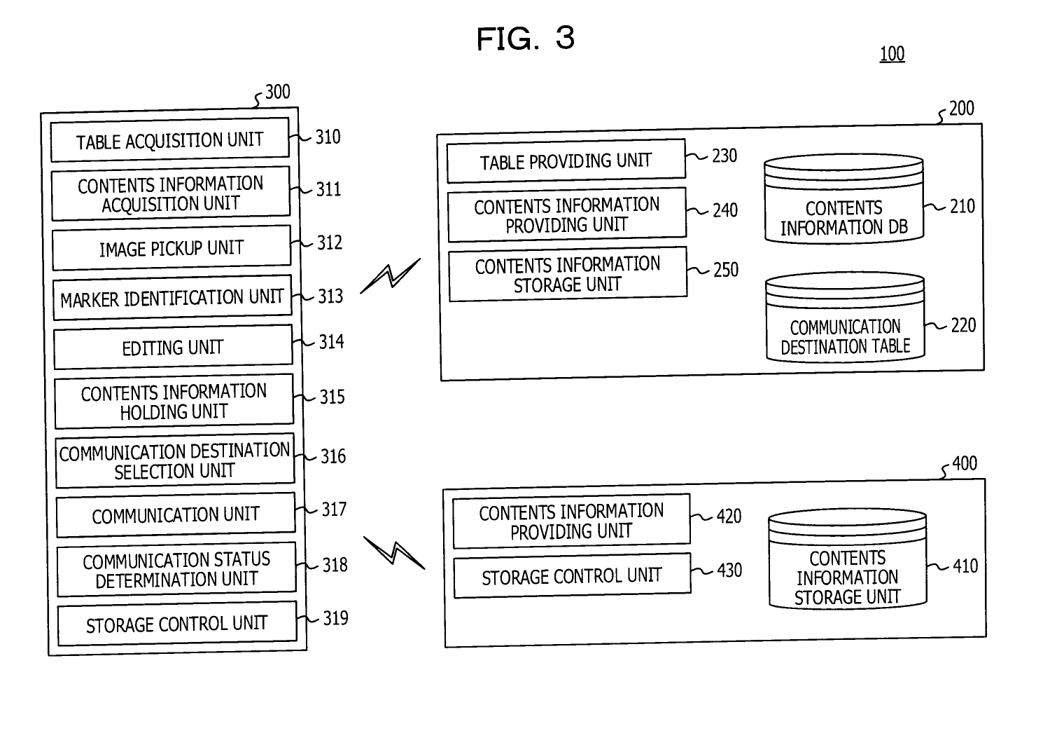

By referring to FIG. 3, a functional configuration of each of the devices included in the control system 100 of the embodiment is described. FIG. 3 is a diagram illustrating a functional configuration of each of the devices included in the control system.

The server 200 of the embodiment has a contents information database 210 and a communication destination table 220. Also, the server 200 of the embodiment has a table providing unit 230, a contents information providing unit 240, and a contents information storage unit 250.

For example, the contents information database 210 stores a marker ID which is obtained by analyzing an image of a marker (AR marker) and contents information, both of which are associated with each other. The contents information database 210 of the embodiment may store multiple marker IDs and contents information associated with each marker.

In the communication destination table 220 of the embodiment, a device storing the marker ID obtained from the marker 10 and the contents information corresponding to the marker ID is associated with a communication method which is used when an access to the device is made. Details of the communication destination table 220 is described later.

The contents information database 210 and communication destination table 220 of the embodiment may be stored in advance in the storage device or the like which is included in the server 200.

The table providing unit 230 of the embodiment provides the terminal device 300 with the communication destination table 220. The contents information providing unit 240 refers to the contents information database 210, and acquires a marker ID of the marker 10 from the terminal device 300, and provides the terminal device 300 with the contents information corresponding to the acquired marker ID. The contents information storage unit 250 stores the contents information received from the terminal device 300 together with the marker ID in the contents information database 210.

The terminal device 300 of the embodiment has a table acquisition unit 310, a contents information acquisition unit 311, an image pickup unit 312, a marker identification unit 313, an editing unit 314, a contents information holding unit 315, a communication destination selection unit 316, a communication unit 317, a communication status determination unit 318, and a display control unit 319.

The table acquisition unit 310 of the embodiment requests the server 200 to provide the communication destination table 220 and acquires the communication destination table 220. The acquired communication destination table 220 is stored in the auxiliary storage device 24 or the memory device 25. The contents information acquisition unit 311 acquires the contents information from the server 200 or the relay device 400.

The image pickup unit 312 picks up an image of a subject to which the marker 10 is attached by controlling the image pickup device 22. The marker identification unit 313 identifies an image of the marker 10 from the image which is captured by the image pickup unit 312 and acquires a marker ID from the image of the marker 10. The editing unit 314 edits the contents information acquired by the contents information acquisition unit 311. The contents information holding unit 315 holds the contents information edited by the editing unit 314.

The communication destination selection unit 316 refers to the communication destination table 220 acquired by the table acquisition unit 310 and selects a communication method and an access destination device which correspond to the marker ID obtained by the marker identification unit 313. The communication unit 317 transmits the contents information to the selected device via the communication method selected by the communication destination selection unit 316. The contents information transmitted here is contents information which is edited by the editing unit 314, for example.

The communication status determination unit 318 determines a communication status of the terminal device 300. Specifically, the communication status determination unit 318 determines if the terminal device 300 and the server 200 are capable of performing mobile data communications. In other words, the communication status determination unit 318 determines if the terminal device 300 is in an area capable of performing mobile data communications with the server 200 (hereinafter referred to as a communication service area) or the terminal device 300 is in an area incapable of performing communications with the server 200 (hereinafter referred to as an area outside a communication service).

The display control unit 319 causes the display operation device 21 to display the captured image by the image pickup unit 312 and the contents information acquired by the contents information acquisition unit 311 in a superimposing manner. Also, the display control unit 319 causes the display operation device 21 to display the contents information edited by the editing unit 314 and the captured image in a superimposing manner.

The relay device 400 of the embodiment has a contents information storage unit 410, a contents information providing unit 420, and a storage control unit 430.

The contents information storage unit 410 stores contents information corresponding to the marker ID of the marker 10 which is transmitted from the terminal device 300, for example. The contents information storage unit 410 of the embodiment may be provided in a predetermined storage region which is included in the relay device 400, for example.

When an access from the terminal device 300 is accepted, the contents information providing unit 420 provides the terminal device 300 with the contents information stored in the contents information storage unit 410. When the contents information transmitted from the terminal device 300 is received, the storage control unit 430 stores the received contents information in the contents information storage unit 410. Specifically, the storage control unit 430 may rewrite the contents information received from the terminal device 300 in the contents information storage unit 410.

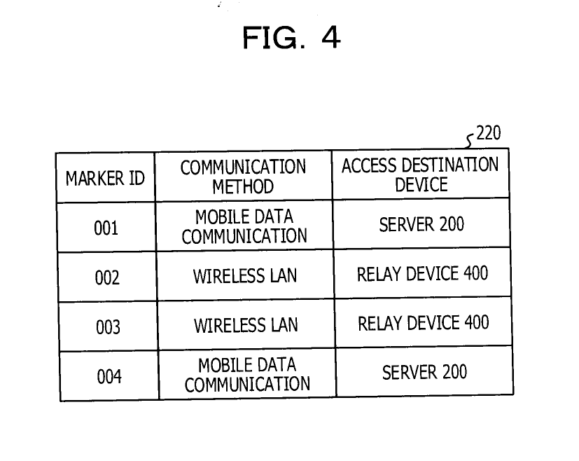

Next, the communication destination table 220 of the embodiment is described by referring to FIG. 4. FIG. 4 is a diagram illustrating an example of a communication destination table.

In the communication destination table 220 of the embodiment, the marker ID which is obtainable by analyzing the marker, a communication method, and an access destination device are associated with one another.

For example, it is to be understood that when the marker ID of the marker 10 is 0002, the terminal device 300 makes an access to the relay device 400 via the wireless LAN.

In the communication destination table 220 of the embodiment, the marker ID, the communication method, and the access destination device are associated with one another, but the present disclosure is not limited to this. For example, the marker ID and the access destination device may be associated with each other in the communication destination table 220. In this case, the terminal device 300 may automatically select the communication method according to the selected access destination device.

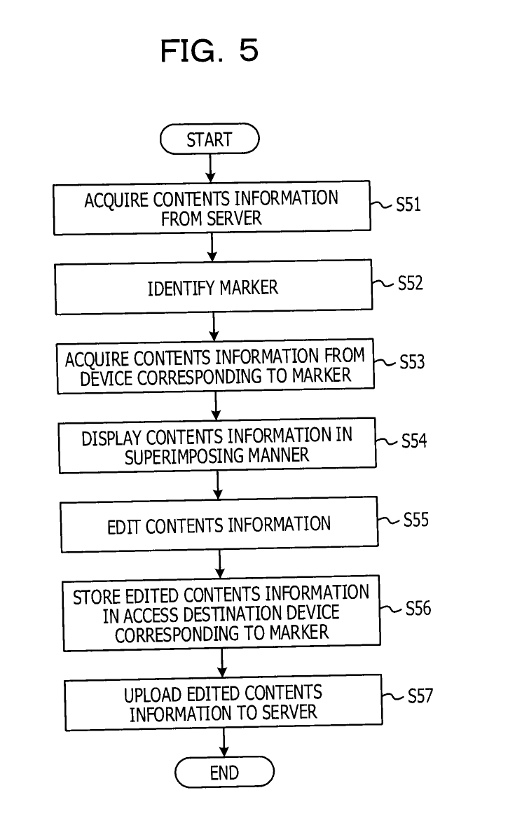

Hereinafter, an operation of the terminal device of the embodiment is described by referring to FIG. 5. FIG. 5 is a flowchart illustrating an operation of the terminal device according to a first embodiment.

It is to be noted that the example of FIG. 5 illustrates a case where the marker ID of the marker 10 whose image is captured by the terminal device 300 is already known.

The terminal device 300 of the embodiment acquires the contents information corresponding to the marker ID from the server 200 by the contents information acquisition unit 311 (step S51). It is to be noted that at this time the terminal device 300 of the embodiment may acquire the communication destination table 220 from the server 200.

Subsequently, the terminal device 300 is moved closer to a subject S by a user of the terminal device 300, for example, and picks up an image of the subject S by the image pickup unit 312. Then, the terminal device 300 identifies an image of the marker 10 from the captured image by using the marker identification unit 313 (step S52).

After that, based on the communication destination table 220, the terminal device 300 selects a device and a communication method which correspond to the identified marker ID by the communication destination selection unit 316 and acquires the contents information corresponding to the marker ID from the device selected by the contents information acquisition unit 311 (step S53).

When the contents information is acquired, the terminal device 300 causes the display control unit 319 to superimpose the acquired contents information on the captured image and causes the display operation device 21 to display the image (step S54). After that, when an editing operation is performed on the contents information in the display operation device 21, the terminal device 300 edits the contents information based on the editing operation by using the editing unit 314 (step S55).

Next, the communication unit 317 stores the edited contents information in the device selected at step S53 (step S56). The terminal device 300 of the embodiment holds the edited contents information by using the contents information holding unit 315.

The terminal device 300 uploads to the server 200 the edited contents information held in the terminal device 300 (step S57).

The control system 100 of the embodiment is specifically described below. In the following description, described as an example is a case where the control system 100 of the embodiment is used for inspecting plant equipment, for example. Also, assumed below is a case where equipment to be inspected are located in an area outside a communication service with the server 200.

In the above-described example, the terminal device 300 is held by an inspector who inspects the equipment. For example, the inspector acquires, from the server 200 located in the plant, contents information corresponding to the marker 10 attached to the equipment to be inspected and the communication destination table 220 in advance. Then, the inspector moves closer to the equipment to be inspected with the terminal device 300 being held by its hand.

Then, the inspector picks up an image of the equipment to be inspected by the terminal device 300. The terminal device 300 acquires a marker ID from the image of the marker 10 included in the captured image. After that, the terminal device 300 refers to the communication destination table 220 and selects an access destination device corresponding to the marker ID. Here, the access destination device is the relay device 400 which is located near the equipment to be inspected. Thus, the terminal device 300 makes an access to the relay device 400 via the wireless LAN communication which is the communication medium with the relay device 400 and acquires the contents information corresponding to the marker ID from the relay device 400. Then, the terminal device 300 displays the contents information after superimposing the contents information on the captured image.

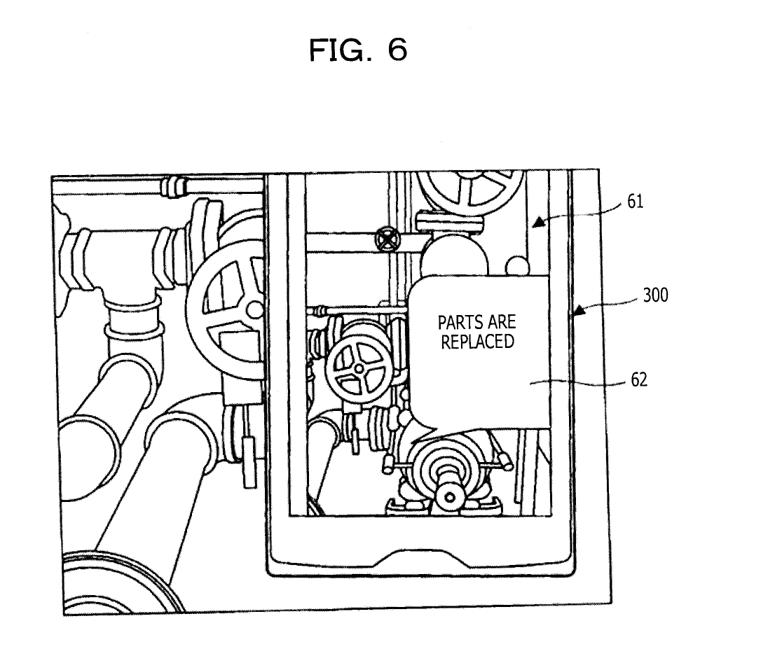

FIG. 6 is a diagram illustrating an example display in which the contents information is superimposed on the captured image. In the example of FIG. 6, the display operation device 21 of the terminal device 300 displays a captured image 61 and contents information 62 superimposed on the captured image 61.

In the embodiment, when the contents information 62 is edited by the display operation device 21, the terminal device 300 transmits the edited contents information 62 to the relay device 400. In the relay device 400, the edited contents information 62 is rewritten on the contents information 62, which is held as the latest state.

The contents information of the embodiment includes, besides the information displayed on the display operation device 21, items of the information include ID of the contents information itself, a display size of the contents information, a location in the 3D space of the contents information, a size of rotation of the contents information, a way of displaying the contents information (if it is displayed in 3D or 2D), and the like.

In addition, the terminal device 300 holds the edited contents information 62 for the uploading later. The inspector only has to upload the edited contents information 62 to the server 200 at any time after moving into the communication service area of the server 200.

In the embodiment, as described above, the access destination device corresponding to the marker ID is determined in advance. This allows each inspector to acquire the latest contents information at the time of picks up an image of the marker 10 regardless of the communication status between the terminal device 300 and the server 200.

In the embodiment, the relay device 400 is located outside the communication service area of the server 200, so that the terminal device 300 is capable of acquiring the latest contents information even when the terminal device 300 is incapable of communicating with the server 200. Accordingly, the occurrence of inconsistency which is caused in sharing the contents information is avoidable.

In the above description, the terminal device 300 acquires the contents information corresponding to the marker 10 from the server 200 in advance, but the present disclosure is not limited to this. For example, the terminal device 300 may acquire the contents information corresponding to the marker 10 from the relay device 400 when the image of the marker 10 is identified without acquiring the contents information from the server 200.

Also, in the embodiment, when the marker ID is acquired by the marker identification unit 313, the terminal device 300 refers to the communication destination table 220 to select an access destination device associated with the marker ID. However, the marker 10 may include information indicating the access destination device corresponding to the marker 10.

In this case, when the image of the marker 10 is identified and analyzed by the marker identification unit 313, the communication destination selection unit 316 of the terminal device 300 may refer to the information indicating the access destination device associated with the marker 10 and select an access destination device.

### Second Embodiment

Hereinafter, a second embodiment is described by referring to the drawings. The second embodiment is different from the first embodiment in that when contents information is transmitted to a relay device 400, the contents information is transmitted to both of the relay device 400 and a server 200 according to a communication status of a terminal device 300. Thus, in the following description of the second embodiment, the description is given to differences with the first embodiment, and the same reference numerals are given to denote the same functional configuration as those of the first embodiment, and the description thereof is omitted.

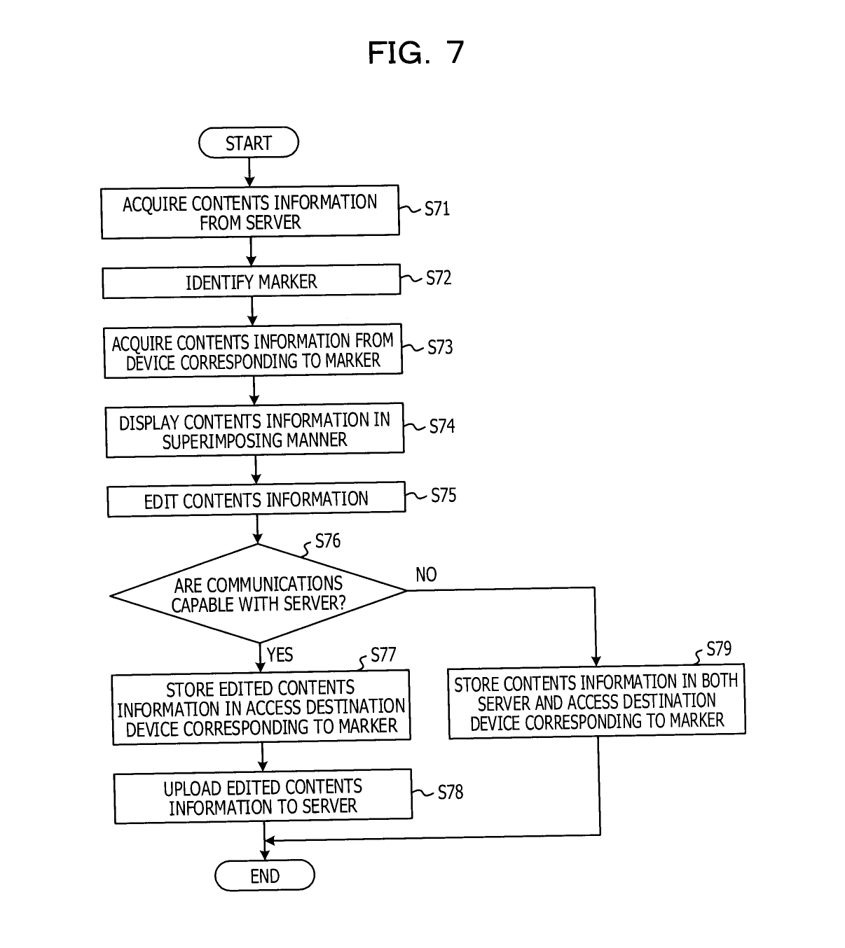

FIG. 7 is a flowchart illustrating an operation of a terminal device according to the second embodiment. Since steps S71 to S75 in FIG. 7 are the same as steps S51 to S55 in FIG. 5, the description thereof is omitted.

When editing the contents information is completed, the terminal device 300 determines if communications with a server 200 are possible by using a communication status determination unit 318 (step S76). Specifically, the communication status determination unit 318 determines if the terminal device 300 itself is in a communication service area of the server 200.

When communications with the server 200 are determined to be impossible at step S76, the terminal device 300 proceeds the processing to step S77. The processes at steps S77 and S78 are the same as those at steps S56 and S57 in FIG. 5, the description thereof is omitted.

When communications with the server 200 are determined to be possible at step S76, the terminal device 300 transmits the edited contents information to both the relay device 400 and the server 200 by using a communication unit 317 (step S79).

As described above, in the embodiment, the edited contents information is transmitted to both the relay device 400 and the server 200 according to the communication status, so that the edited contents information is uploaded at once to the relay device 400 and the server 200.

It is to be noted that the terminal device 300 of the embodiment may upload the edited contents information to all devices whose marker IDs of marker 10 are stored, of devices capable of communicating with the terminal device 300, for example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer readable storage medium storing a program, which when executed by a computer including an image capturing device and a display, causes the computer to:
obtain identification information associated with a specific object in an image captured by the image capturing device,
determine an access destination to be accessed for acquiring content data, from among a server which communicates with the computer via a first network or a local storage device which communicates with the computer via a second network different from the first network, based on the identification information,
acquire the content data from the determined access destination, and
control the display to superimpose a specific image corresponding to the acquired content data on the image.

2. The non-transitory computer readable storage medium according to claim 1, wherein the first network is a mobile data communication network, and the second network is a local area network.

3. The non-transitory computer readable storage medium according to claim 1, wherein the program causes the computer to:
edit the content data based on a user instruction, and
send the edited content data to the determined access destination.

4. The non-transitory computer readable storage medium according to claim 3, wherein the user instruction is received from a touch panel of the display.

5. The non-transitory computer readable storage medium according to claim 4, wherein, when the local storage device is determined as the access destination, the program causes the computer to further send the edited content data to the server.

6. The non-transitory computer readable storage medium according to claim 3, wherein the edited content data is stored in a memory of the computer.

7. The non-transitory computer readable storage medium according to claim 1, wherein the local storage device is located outside of a communication service area of the first network.

8. The non-transitory computer readable storage medium according to claim 1, wherein
the server stores a plurality of content data including the content data, the plurality of content data being associated with a plurality of objects including the specific object and,
the local storage device stores the content data associated with the specific object.

9. The non-transitory computer readable storage medium according to claim 1, wherein the access destination to be accessed is determined based on communication destination data corresponding to the identification information.

10. The non-transitory computer readable storage medium according to claim 9, wherein the communication destination data includes information associated with a plurality of objects, each of the information indicating whether to communicate via the first network or via the second network.

11. The non-transitory computer readable storage medium according to claim 9, wherein the program causes the computer to:
acquire the communication destination data from the server in advance, and
store the communication destination data into a memory.

12. The non-transitory computer readable storage medium according to claim 1, wherein the specific object includes a marker.

13. The non-transitory computer readable storage medium according to claim 1, wherein the identification information is acquired by recognizing the marker in the image and analyzing texture of the marker.

14. A control device configured to:
an image capturing device configured to capture an image;
a display; and
circuitry configured to:
obtain information associated with a specific object in the image,
determine an access destination to be accessed for acquiring content data, from among a server which communicates with the computer via a first network or a local storage device which communicates with the computer via a second network, based on the obtained information,
acquire the content data from the determined access destination, and
control the display to superimpose a specific image corresponding to the acquired content data on the image.

15. The control device according to claim 14, wherein the first network is a mobile data communication network, and the second network is a local area network.

16. The control device according to claim 14, wherein the circuitry is configured to:
edit the content data based on a user instruction, and
send the edited content data to the determined access destination.

17. A system, comprising:
the control device according to claim 14;
the server according to claim 14; and
the local storage device according to claim 14, and
wherein the server stores a plurality of content data including the content data, the plurality of content data being associated with a plurality of objects including the specific object, and the local storage device stores the content data associated with the specific object.

18. A control method executed by a processor that controls an image capturing device and a display, the control method comprising:
obtaining information associated with a specific object in an image captured by the image capturing device;
determining, by the processor, an access destination to be accessed for acquiring content data, from among a server which communicates with the computer via a first network or a local storage device which communicates with the computer via a second network, based on the obtained information;
acquiring the content data from the determined access destination; and
controlling the display to superimpose a specific image corresponding to the acquired content data on the image.

19. The control method according to claim 18, wherein the first network is a mobile data communication network, and the second network is a local area network.

20. The control method according to claim 18, further comprising:
editing the content data based on a user instruction, and
sending the edited content data to the determined access destination.
